(19) United States
(12) Patent Application Publication
(10) Pub. No.: US 2013/0024230 A1
(43) Pub. Date: Jan. 24, 2013

(54) METHOD OF EXTENDING ACTIVITY FLOATS IN THE CRITICAL PATH METHOD

(71) Applicant: King Fahd University Of Petroleum And Minerals, Dhahran (SA)

(72) Inventor: ASHRAF MOHAMMED ATTIA ELAZOUNI, DHAHRAN (SA)

(73) Assignee: KING FAHD UNIVERSITY OF PETROLEUM AND MINERALS, DHAHRAN (SA)

(21) Appl. No.: 13/626,564

(22) Filed: Sep. 25, 2012

Related U.S. Application Data
(63) Continuation-in-part of application No. 12/848,907, filed on Aug. 2, 2010.

(51) Int. Cl. G06Q 10/06

(52) U.S. Cl. 705/7.16

(57) ABSTRACT

The method of extending floats in the critical path method (CPM) method allows for extending the project duration while keeping the networking basic parameter of total float intact. The method allows for rescheduling of the start times of some activities so that the resource requirements never exceed the specified resource limit. The extendable network transforms the process of seeking an extended schedule that fulfills resource constraints from searching in a boundless solution space to searching in a well-defined and definite solution space. The definite searching space harnesses for the mathematical formulation of the optimization techniques, i.e., integer programming, which provides the optimum solution as a schedule that fulfills the resource constraint and yet minimizes the project duration.

### CROSS-REFERENCE TO RELATED APPLICATION

This application is a continuation-in-part of my prior U.S. patent application, Ser. No, 12/848,907, filed Aug. 2, 2010.

### BACKGROUND OF THE INVENTION

1. Field of the Invention

The present invention relates to computerized scheduling systems, and more specifically to a method of extending activity floats in the critical path method (CPM).

2. Description of the Related Art

There are many techniques that were developed in the literature to schedule construction projects based on different concepts. For example, in CPM, a critical path is the sequence of project network activity durations that adds up to the longest overall duration. This determines the shortest time possible to complete the project. Any delay of an activity on the critical path directly impacts the planned project completion date (i.e., there is no float on the critical path). A project can have several parallel, near critical paths. An additional parallel path through the network with the total durations shorter than the critical path is called a sub-critical or non-critical path.

The CPM scheduling technique was developed with an underlying concept of minimizing the project duration. Subsequently, many algorithms have been developed to enhance the CPM technique. Among these algorithms, resource management techniques offer a substantial enhancement. The literature involves many heuristic, optimal, and sub-optimal methods that have been developed to modify CPM schedules to account for practical considerations of project resources.

Activities with floats are project activities that can be delayed without making the project longer. Despite the fact that resource management techniques entail rescheduling the start of some activities, which occasionally involves extending the total project duration, the inventor is unaware of any work having been introduced to devise an extendable network to allow extending the project duration by supplementing the original total floats of activities with an additional float.

Although many techniques have been developed to schedule the resources of the construction projects, these techniques suffer from the disadvantage that they have not devised an extendable network that fulfills the constrained resources by supplementing the original total floats of activities with an additional float.

Thus, a method of extending activity floats in the critical path method solving the aforementioned problems is desired.

### SUMMARY OF THE INVENTION

A network diagram of a project shows which activities follow and depend from other activities. Critical paths, i.e., routes through the network that will take the longest amount of time, are identified. Activities with floats display project activities that can be delayed without affecting the critical paths. A basic network parameter of total float is computed for all the activities in the network. The method of extending activity floats in the critical path method (CPM) retains the computed total float while supplementing them with extra float, resulting in an extendable network. The method allows for rescheduling of the start times of some activities so that the resource requirements never exceed the specified resource limit.

The extendable network transforms the process of seeking an extended schedule that fulfills resource constraints from searching in a boundless solution space to a process of searching in a well-defined and definite solution space. Utilization of a definite searching space allows for the formulation of an integer programming optimization model, which provides an optimized scheduling solution that fulfills the resource constraint and yet minimizes the project duration.

These and other features of the present invention will become readily apparent upon further review of the following specification and drawings.

### BRIEF DESCRIPTION OF THE DRAWINGS

FIG. 1 is a schematic diagram of a typical activity, k, in a CPM schedule.

FIG. 2 is a chart of a cash flow profile for the CPM schedule of L periods.

FIG. 3 is a plot that shows cumulative cash as of end of period t, which encompasses in days, including accumulated interest charges.

FIG. 4 is a schematic diagram illustrating the extendable network.

FIG. 5 is a flowchart illustrating the solution search logic in a method of extending activity floats in the critical path method (CPM) according to the present invention.

FIG. 6A is a chart showing an original CPM schedule before application of a method of extending activity floats in the critical path method (CPM) according to the present invention.

FIG. 68 is a chart showing the original CPM Schedule with a 5-day additional float after application of a method of extending activity floats in the critical path method (CPM) according to the present invention,

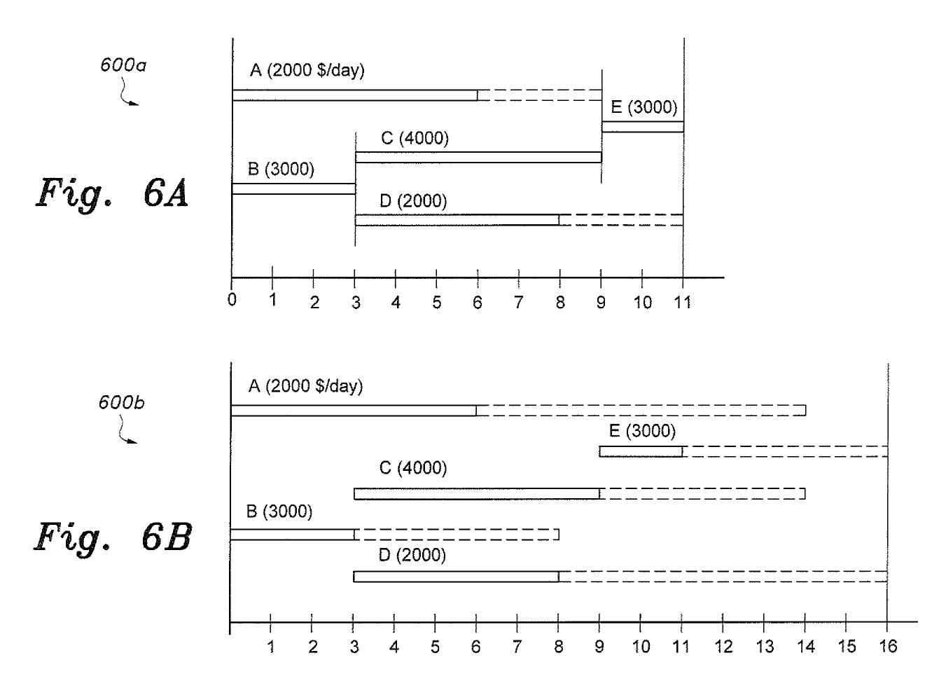

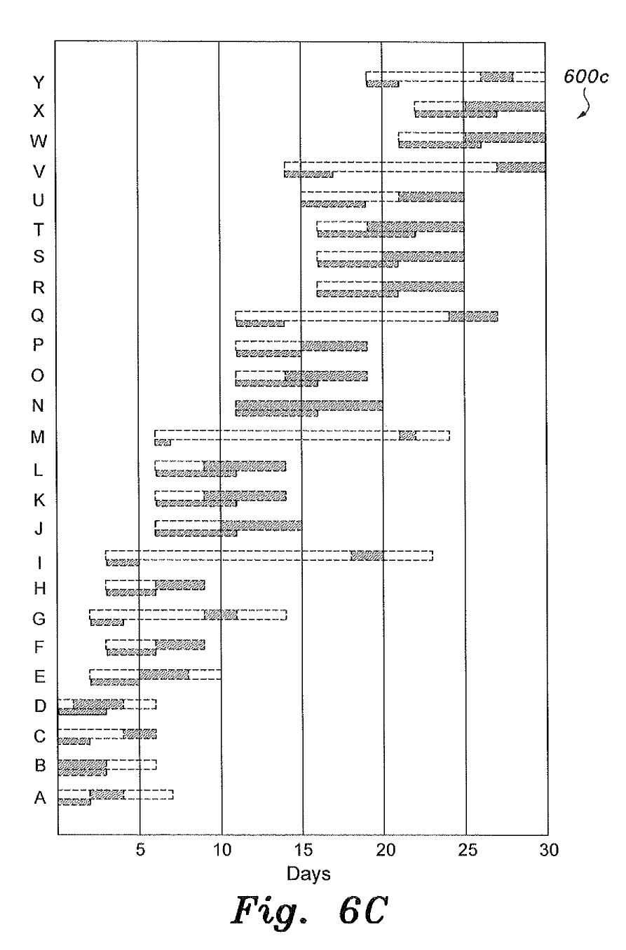

FIG. 6C is a chart showing the original CPM Schedule with a 3-day additional float after application of the method of extending activity floats in the critical path method (CPM) according to the present invention.

Similar reference characters denote corresponding features consistently throughout the attached drawings.

### DETAILED DESCRIPTION OF THE PREFERRED EMBODIMENTS

A network diagram of a project shows which activities follow and depend from other activities. Critical paths, i.e., routes through the network that will take the longest amount of time are identified. Activity floats display project activities that can be delayed without affecting the critical paths. A basic network parameter of total float is computed for all the activities in the network. The method of extending activity floats in the critical path method (CPM) retains the computed total float while supplementing them with extra float, resulting in an extendable network. The method allows for extending the project duration while keeping the networking basic parameter of total float intact. The method provides for rescheduling of the start times of some activities while constraining the resource requirements so that the requirements never exceed a specified resource limit.

The extendable network transforms the process of seeking an extended schedule that fulfills resource constraints from searching in a boundless solution space to a process of searching in a well-defined and definite solution space. The definite searching space can be utilized by optimization techniques, such as integer programming, which provide the optimum solution as a schedule that fulfills the resource constraint and yet minimizes the project duration. The method of extending activity floats in the critical path method (CPM) uses the extension framework to devise cash-constrained schedules for construction projects. Even though this is the preferred embodiment, the method does not preclude being implemented in various manifestations other than the one described here.

The method of extending activity floats to fulfill cash constraints in the critical path method (CPM) networks comprises three primary stages, including the preparation of the input, the preparation of the extendable network, and the formulation of the mathematical model of the cash-constrained scheduling problem.

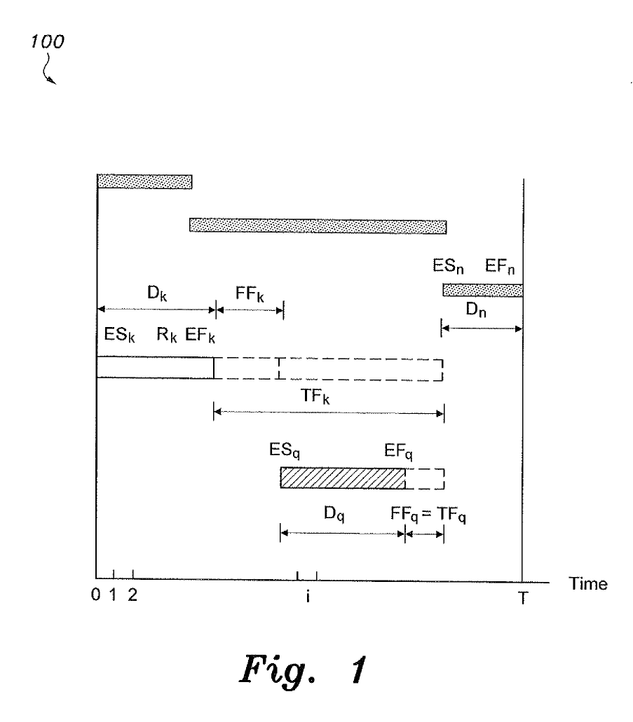

The input preparation stage supports preparing CPM schedule and financial data of the project, which involves activities, sequence of activities, time data, cash outflow data, cash inflow data, and the cash flow profile. The time data involves durations, early start times, early finish times, late start times, late finish times, and total floats of activities. Cash outflow data involves identification of cost elements and determination of daily disbursement rates of activities. Cash inflow data involves unit prices of the activities, the frequency of payments, and the retained percentage of the payments. A cash flow profile charts the cash inflow and cash outflow transactions along the project duration. The terminology of schedule and financial data is described below with reference to FIGS. 1, 2, and 3.

FIG. 1 represents a schematic diagram 100 of a typical activity k in a CPM schedule. Activity k has a duration Dₖ, a free float FFₖ, a total float TFₖ, an early start time ESₖ, an early finish time EFₖ, and a disbursement rate Rₖ, which includes direct costs of material, labor, equipment, and subcontractors, and indirect costs of overheads, bonds, and taxes. The activity k=1,2, . . . , n, where n is the number of project activities. An activity q is a representative activity of the set of activities Qₖ that depend on activity k. Activity q has a duration D_{q}, a free float FF_{q}, which is the same as the total float TF_{q}, an early start time ES_{q}, and an early finish time EF_{q}. An activity n, designated by a solid bar in FIG. 1, is a representative activity of project critical activities. At the same time, it is the terminating activity in the CPM schedule. Activity n has a duration Dₙ, an early start time ESₙ, and an early finish time EFₙ. A duration T of the CPM schedule is the total number of working days, and i denotes a typical working day of the CPM schedule.

Let total disbursements of all activities performed in day i be denoted by yᵢ; this will be referred to as project disbursements at day i. Thus:

$${y}_{i} = {\sum }_{1}^{ni} {y}_{pi} \qquad ( 1 )$$

where nᵢ is the number of activities that have their durations or float values overlapping with day i, and yₚᵢ is the disbursement rate of activities in terms of Rₖ values, as formulated in Equations 16a through 16c, below.

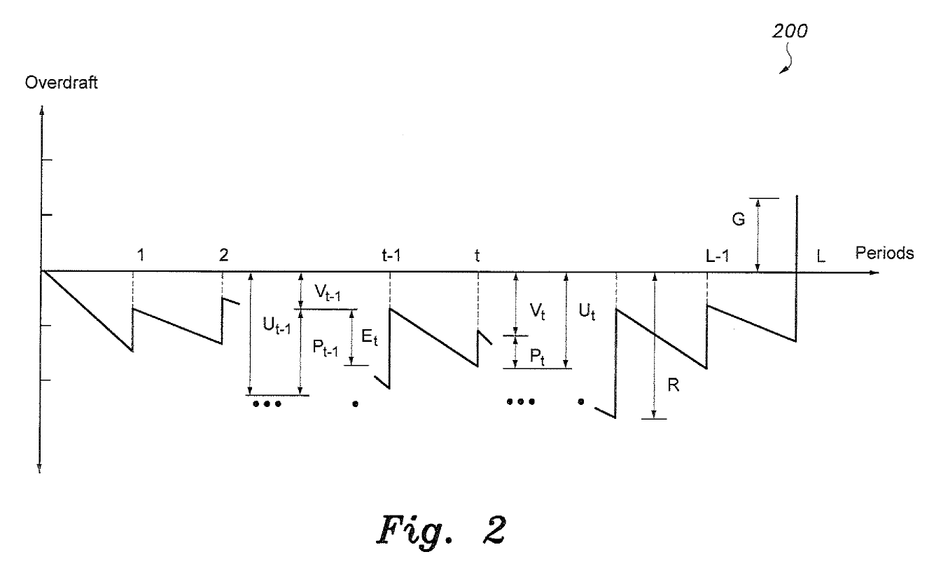

Cash flow profile 200 is shown in FIG. 2 for the CPM schedule of L periods. The cash flow profile is from the contractors' perspective. Cash outflow during a typical project period t is represented by Eₜ, timing of receipts from the owner is at the end of the same period, and a cash inflow is represented by Pₜ; where:

$$\begin{matrix}{E}_{t} = {\sum }_{i = 1}^{m} {y}_{i} & ( 2 ) \\ {P}_{t} = K \cdot {E}_{t} & ( 3 )\end{matrix}$$

where; m is the number of days comprising period t, as will be indicated in FIG. 2, and K is a multiplier to account for deduction of the percentage owners cut of receipts. A cumulative cash flow as of the end of period t (for t≧1) is Uₜ, where:

Uₜ=Vₜ₋₁+Eₜ (4)

A net cash flow at the end of period t after receiving cash inflow is Vₜ. At the end of the previous period (t−1), FIG. 2 shows also a cumulative cash Uₜ₋₁, cash inflow as of end of period Pₜ₋₁, and a cumulative balance Vₜ₋₁, where:

Vₜ₋₁=Uₜ₋₁+Pₜ₋₁ (5)

FIG. 2 shows a net profit G achieved at end of project, and a maximum cumulative cash R occurred along cash flow profile. It is to be noted that, the above calculations are based on the premise that contractors pay interest charges due at end of each period, where interest charges Oₜ at end of period t is:

$${O}_{t} = {rV}_{t - 1} + r \frac{{E}_{t}}{2} \qquad ( 6 )$$

where r is an interest rate per period.

The first component of Oₜ represents interest charges per period on net cash flow Vₜ₋₁. The second component approximates interest charges on Eₜ.

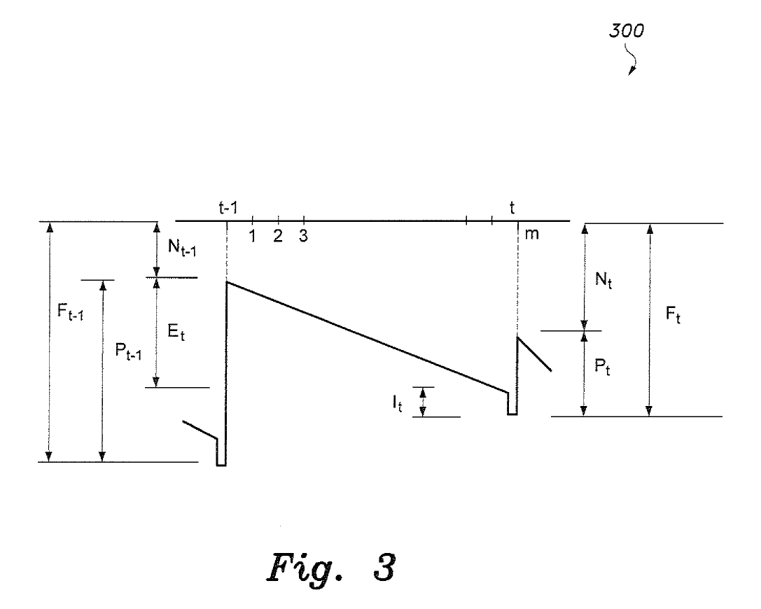

However, if contractors pay interest charges on accumulated cash at interest rate r, plot 300 of FIG. 3 shows that a cumulative cash as of end of period t, which encompasses m days, including accumulated interest charges is designated by Fₜ where:

Fₜ=Uₜ+Iₜ (7)

where Iₜ is accumulated interest charges as of end of period t.

$${I}_{t} = {\sum }_{l = 1}^{t} {{O}_{l} ( 1 + r )}^{t - 1} \qquad ( 8 )$$

A cumulative balance as of end of period t is Nₜ where:

Nₜ=Fₜ+Pₜ (9)

For period t−1, cumulative cash as of the end of this period, including accumulated interest charges, is Fₜ₋₁, and the cumulative balance is Nₜ₋₁.

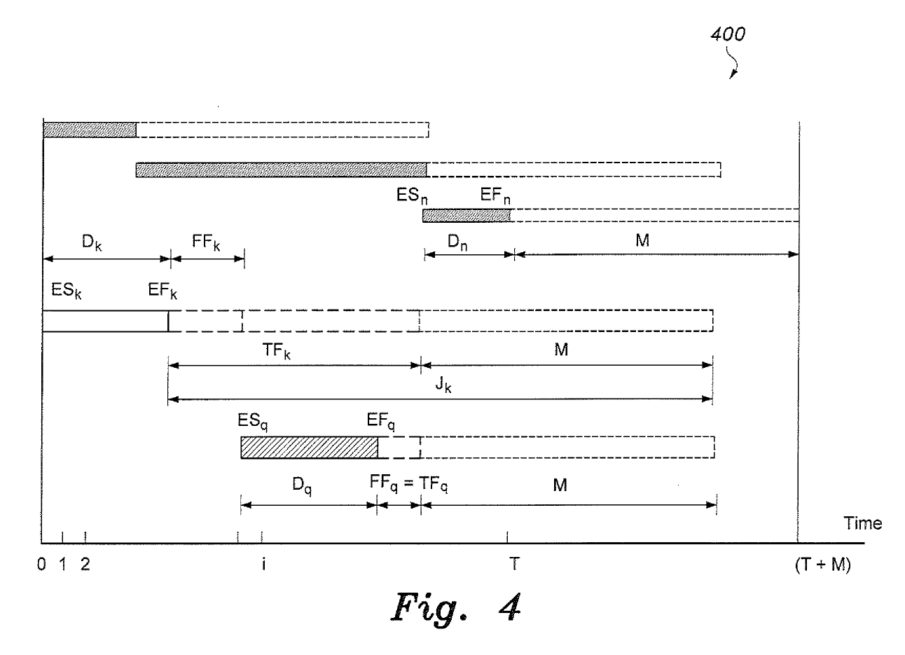

Developing CPM schedules that are constrained with specified constrained cash involves extension rather than compression in these schedules. Practically, numerous extended schedules could be produced for a given schedule. Thus, a fundamental objective of the method is to minimize extension in schedules. This stage of the method supports developing the extendable network. The extendable network, illustrated by plot 400 shown in FIG. 4, is a structure of the original schedule that supplements a definite additional float M to the original network duration to determine the extended duration of the CPM network (T+M), and consequently to the total floats of activities to produce the extended floats This can be expressed as:

Jₖ=M+TFₖ (10)

The extended floats are time spaces within which activities can be shifted without impacting the duration of the extended CPM network. For instance, in FIG. 4, activity k can be shifted all the way to the end of its illustrated extended float. Consequently, activity n should be shifted to the end of its extended float to maintain the relation that activity n depends on activity k. Thus, the shift of activity k can be done without causing further extension beyond the duration of (T+M). The same scenario is valid between activities q and n.

The activities plot 600c of FIG. 6C most clearly illustrates the extension scheme which is a special framework for extending the project duration while keeping the networking basics intact. As shown in FIG. 6C, the early-start bar chart of the 25-activity project is charted using thin bars, and the extension scheme is indicated by dotted bars. This extension scheme adjusts the original schedule by adding a 3-day extension increment to the original project duration of 27 days. The total float of the terminating activity of the network is supplemented with the 3-day extension. Since the total float of a given activity is shared by all activities on its path, and given that the terminating activity is a common activity in all paths traversing the network, the extension increment is shared by all activities of the network. Thus, the total float values of all the network activities are supplemented with 3 days. In other words, the late-start and late-finish times of the network activities are delayed by 3 days. The bars with dotted lines in FIG. 6C indicate the ranges from the early-start times to the delayed late-finish times. The present activity float extending method utilizes a computer program to generate 20 schedules for the 3-day extension scheme by assigning random values to the activities' start times within the ranges intercepted between the activities' early-start and delayed late-start times, while maintaining the dependencies amongst activities. The thick bars shown in FIG. 6C represent one possible schedule.

With respect to the extension increment, it is shared, managed, and distributed as a fundamental project resource to produce feasible schedules under constrained cash. The extendable network allows rescheduling the start times of some activities such that Fₜ values never exceed the specified constrained cash. Thus, the extendable network transforms the process of seeking an extended schedule that fulfills cash constraints from a process of searching in a boundless solution space to a process of searching in a well-defined and definite solution space.

The mathematical model formulation stage supports building an integer programming model, which involves the components of formulating an objective function, setting constraints, and searching for a model solution. Constraints involve activity shifting, activity sequence, and specified constrained cash. Model solution determines activity shifts that minimize project duration fulfilling constraints, activity shifting, activity sequence, and specified constrained cash.

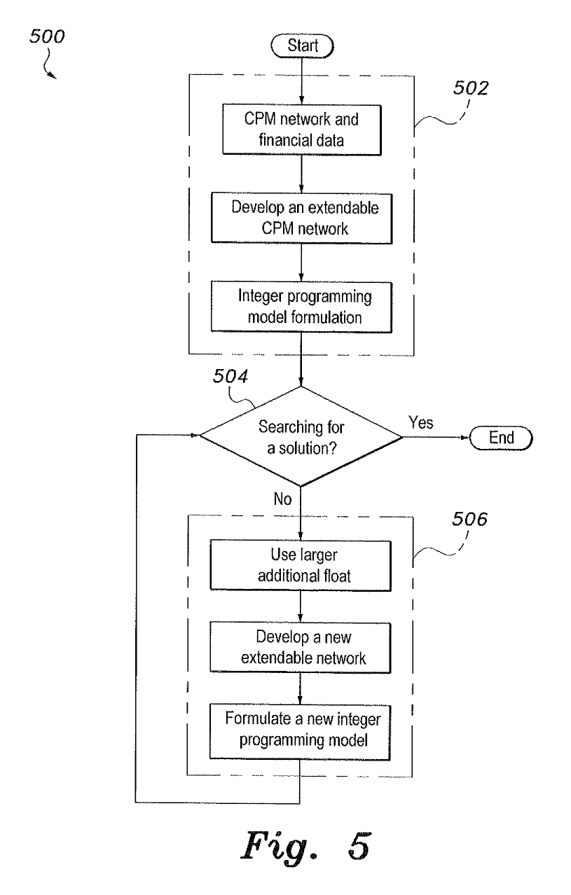

The process flow 500, as shown in FIG. 5, details the searching logic for a solution. The steps of process flow 500 include step 502, in which the CPM network and financial data are acquired, an extendable CPM network is developed, and an integer programming model is formulated. At step 504, a solution search is performed. The process 500 terminates if the solution is found. If a solution is not found, then step 506 is performed, in which the extendable network developing procedure and the integer programming model formulation procedure are repeated using a larger additional float.

Thus, searching for a solution under constrained cash is an iterative process. Each iteration uses a larger additional float than the previous iteration. Many iterations being performed (iterations exceeding a predetermined threshold) with no solution indicates insufficient cash.

The method produces realistic schedules as far as cash availability is concerned, and thus establishes the feasibility of schedules. It builds on the widely spread CPM technique, and thus is readily plausible for practitioners. It achieves financial feasibility, besides the demanded goal of time minimization. The method employs the optimization technique of integer programming to give optimum solutions. It defines an extendable network of schedules to achieve minimum extension of the total duration. It transforms the process of seeking an extended schedule that fulfills cash constraints from a process of searching in a boundless region to a process of searching in a well-defined and definite region. Moreover, the method provides a sensitivity analysis technique through the gradual increase in the additional float.

A decision variable x denotes a shift in activity. As mentioned above, the objective of the model is to minimize total extension of a schedule through minimizing shifting in activity n. Thus, the objective function can be formulated as:

Minimize z=xₙ (11)

Activity shifting constraints insures that shifting in activities xₖ where k=1,2, . . . n and n is the total number of activities, is an integer within the extended float. Shifting of activities xₖ can be represented by:

$$\begin{matrix}{x}_{k} = {\sum }_{j = 1}^{{J}_{k}} {jS}_{kj} & ( 12 ) \\ {\sum }_{j = 1}^{{J}_{k}} {S}_{kj} \leq 1 & ( 13 )\end{matrix}$$

where Jₖ=extended float of activity k, and Sₖⱼ ∈ {0,1} is a binary variable. These equations ensure that xₖ takes values of 0, 1, 2, . . . , Jₖ and only one of these values is considered at a time. In other words, equation (13) means that only one Sₖⱼ is equal to I and the others are equal to zero (in this case xₖ=jₖ) or all Sₖⱼ equal zero (in this case, xₖ=0). Thus, equations (12) and (13) allow xₖ to take all possible values from 0 up to Jₖ

Requisite activity sequence constraints are constraints between activity k and each of activities q ∈ Qₖ. This is because early finish time of each activity q must be equal to or more than early finish of activity k plus duration of activity q. This can be represented mathematically by:

EF_{q}≧(EFₖ+D_{q}) k=1, 2, . . . , n for all q ∈ Qₖ (14)

Cumulative cash at any period t, including accumulated interest charges Fₜ, should not exceed specified constrained cash of W. This constraint can be formulated as follows:

Fₜ≦W (15)

Fₜ, as in equation (7), for each period of the project can be formulated in terms of disbursement rate yₚᵢ using equations (1) through (8), respectively. Disbursement rate yₚᵢ can be formulated as in equations (16a)-(16c). It is noted that equations (16a)-(16c) use subscript k to illustrate activity k, but it should be used for all activities p that are performed in time unit i.

For activity k of disbursement rate Rₖ, the disbursement rate in time unit i can be calculated as follows:

$$\begin{matrix}\begin{matrix}{y}_{ki} = ( 1 - {\sum }_{j = 1}^{{J}_{k}} {S}_{kj} ) {R}_{k} ; & {ES}_{k} \leq i \leq {EF}_{k}\end{matrix} & ( 16 a ) \\ \begin{matrix}{y}_{ki} = {S}_{kj} \cdot {R}_{k} ; & \begin{matrix}{ES}_{k} + j \leq i < {EF}_{k} + j & j = 1 , 2 , … , {J}_{k}\end{matrix}\end{matrix} & ( 16 b ) \\ \begin{matrix}{y}_{ki} = 0 ; & otherwise\end{matrix} & ( 16 c )\end{matrix}$$

As noted from equation (16a), when ΣSₖⱼ=0 (i.e., xₖ=0), from equation (12)), the disbursement rate Rₖ will be considered for each time unit within ESₖ and EFₖ. As also noted from equation (16b), when any S_{kJ}=1 (i.e., xₖ=jₖ from equations (12) and (13), the disbursement rate Rₖ will be considered for each time unit in which activity k is performed in its shifted position.

Finally, objective function and constraints are formulated in terms of Sₖⱼ variables. Thus, model constraints and the objective function represent an integer optimization model that can be implemented as computer software, which, when executed by a computer, directly solves the model. Non-zero variables indicate shifts. For instance, if Sₖ₃=1, that indicates a value shift in activity k of three time units.

An illustrative CPM schedule example is used to demonstrate the method. Plot 600a of FIG. 6A shows the original schedule, consisting of five activities. A disbursement rate ($/day) is indicated above each activity. The diagram 600b is shown in FIG. 6B with a five day additional float. The extended duration is sixteen working days, which represents three full periods, each full period comprising five working days, and a fourth partial period of one day.

Using equation (12) to formulate the shift in activity E of the schedule, and substituting in Equation (11), the objective function of the example schedule becomes:

Minimize Z=S_{E1}+2S_{E2}+3S_{E3}+4S_{E4}+5S_{E5} (17)

Referring to FIG. 6A, equation (14) can be interpreted in terms of shifts as follows for activities A, B, C, D, and E, and constraints on the shifts. [00521 The shift of activity A should not be greater than the shift of activity E by three days, which is total float of A. The shift of activity B should not be greater than the shift of activity C. The shift of activity B should not be greater than the shift of activity D. The shift of activity C should not be greater than the shift of activity E.

The shift of activity D should not be greater than the shift of activity B by three days, which is total float of D. This is to insure that the schedule duration remains determined by the end of activity E.

Using equation (12) to formulate shifts of activities A, B, C, D, and E, the above five constraints are respectively formulated as follows:

S_{A1}+2S_{A2}+3S_{A3}+4S_{A4}30 5S_{A5}+6S_{A6}+7S_{A7}+8S_{A8}−S_{E1}−2S_{E2}−3S_{E3}−4S_{E4}−5S_{E5}≦3 (18)

S_{B1}+2S_{B3}+3S_{B3}+4S_{D4}+5S_{B5}−S_{C1}−2S_{C2}−3S_{C3}−4S_{C4}−5S_{C5}≦0 (19)

S_{B1}+2S_{B3}+3S_{B3}+4S_{B4}+5S_{B5}−S_{D1}−2S_{D2}−3S_{D3}−4S_{D4}−5S_{D5}−6S_{D6}−7S_{D7}−8S_{D8}≦0 (20)

S_{C1}+2S_{C2}+3S_{C3}+4S_{C4}+5S_{C5}−S_{E1}−2S_{E2}−3S_{E3}−4S_{E4}−5S_{E5}≦0 (21)

S_{D1}+2S_{D2}+3S_{D3}+4S_{D4}+5S_{D5}+6S_{D6}+7S_{D7}+8S_{D8}−S_{E1}−2S_{E2}−3S_{E3}−4S_{E4}−5S_{E5}≦3 (22)

Referring to equation (13), activity shifting constraints can be formulated as follows for activities A, B, C, D, and E.

S_{A1}+S_{A2}+S_{A3}+S_{A4}+S_{A5}+S_{A6}+S_{A7}+S_{A8}≦1 (23)

S_{B1}+S_{B3}+S_{B3}+S_{B4}+S_{B5}≦1 (24)

S_{C1}+S_{C2}+S_{C3}+S_{C4}+S_{C5}≦1 (25)

S_{D1}+S_{D2}+S_{D3}+S_{D4}+S_{D5}+S_{D6}+S_{D7}+S_{D8}≦1 (26)

S_{E1}+S_{E2}+S_{E3}+S_{B4}+S_{E5}−1 (27)

Referring to FIG. 6B, project daily disbursement yᵢ in equation 1 can be formulated for sixteen days using equations (16a), (16b), and (16c) as follows:

$$\begin{matrix}{y}_{1} = 5000 - 2000 {S}_{A 1} - 2000 {S}_{A 2} - 2000 {S}_{A 3} - 2000 {S}_{A 4} - 2000 {S}_{A 5} - 2000 {S}_{A 6} - 2000 {S}_{A 7} - 2000 {S}_{A 8} -- 3000 {S}_{B 1} - 3000 {S}_{B 2} - 3000 {S}_{B 3} - 3000 {S}_{B 4} - 3000 {S}_{B 5} & ( 28 ) \\ {y}_{2} = 5000 - 2000 {S}_{A 2} - 2000 {S}_{A 3} - 2000 {S}_{A 4} - 2000 {S}_{A 5} - 2000 {S}_{A 6} - 2000 {S}_{A 7} - 2000 {S}_{A 8} - 3000 {S}_{B 2} - 3000 {S}_{B 3} - 3000 {S}_{B 4} 3000 {S}_{B 5} & ( 29 ) \\ {y}_{3} = 5000 - 2000 {S}_{A 3} - 2000 {S}_{A 4} - 2000 {S}_{A 5} - 2000 {S}_{A 6} - 2000 {S}_{A 7} - 2000 {S}_{A 8} - 3000 {S}_{B 3} - 3000 {S}_{B 4} - 3000 {S}_{B 5} & ( 30 ) \\ {y}_{4} = 8000 - 2000 {S}_{A 4} - 2000 {S}_{A 5} - 2000 {S}_{A 6} - 2000 {S}_{A 7} - 2000 {S}_{A 8} + 3000 {S}_{B 1} + 3000 {S}_{B 2} + 3000 {S}_{B 3} - 4000 {S}_{C 1} - 4000 {S}_{C 2} - 4000 {S}_{C 3} - 4000 {S}_{C 4} - 4000 {S}_{C 5} - 2000 {S}_{D 1} - 2000 {S}_{D 2} - 2000 {S}_{D 3} - 2000 {S}_{D 4} - 2000 {S}_{D 5} - 2000 {S}_{D 6} - 2000 {S}_{D 7} - 2000 {S}_{D 8} & ( 31 ) \\ {y}_{5} = 8000 - 2000 {S}_{A 5} - 2000 {S}_{A 6} - 2000 {S}_{A 7} - 2000 {S}_{A 8} + 3000 {S}_{B 2} + 3000 {S}_{B 3} + 3000 {S}_{B 4} - 4000 {S}_{C 2} - 4000 {S}_{ C 3} - 4000 {S}_{C 4} - 4000 {S}_{C 5} - 2000 {S}_{D 2} - 2000 {S}_{D 3} - 2000 {S}_{D 4} - 2000 {S}_{D 5} - 2000 {S}_{D 6} - 2000 {S}_{D 7} - 2000 {S}_{D 8} & ( 32 ) \\ {y}_{6} = 8000 - 2000 {S}_{A 6} - 2000 {S}_{A 7} - {2000}_{A 8} + 3000 {S}_{B 3} + 3000 {S}_{B 4} + 3000 {S}_{B 5} - 4000 {S}_{C 3} - 4000 {S}_{C 4} - 4000 {S}_{C 5} - 2000 {S}_{D 3} - 2000 {S}_{D 4} - 2000 {S}_{D 5} - 2000 {S}_{D 6} - 2000 {S}_{D 7} - 2000 {S}_{D 8} & ( 33 ) \\ {y}_{7} = 6000 + 2000 {S}_{A 1} + 2000 {S}_{A 2} + 2000 {S}_{A 3} + 2000 {S}_{A 4} + 2000 {S}_{A 5} + 2000 {S}_{A 6} + 3000 {S}_{B 4} + 3000 {S}_{B 5} - 4000 {S}_{C 4} - 4000 {S}_{C 5} - 2000 {S}_{D 4} - 2000 {S}_{D 5} - 2000 {S}_{D 6} - 2000 {S}_{D 7} - 2000 {S}_{D 8} & ( 34 ) \\ {y}_{8} = 6000 + 2000 {S}_{A 2} + 2000 {S}_{A 3} + 2000 {S}_{A 4} + 2000 {S}_{A 5} + 2000 {S}_{A 6} + 2000 {S}_{A 7} + 3000 {S}_{B 5} - 4000 {S}_{C 5} - 2000 {S}_{D 4} - 2000 {S}_{D 5} - 2000 {S}_{D 6} - 2000 {S}_{D 7} - 2000 {S}_{D 8} & ( 35 ) \\ {y}_{9} = 4000 + 2000 {S}_{A 3} + 2000 {S}_{A 4} + 2000 {S}_{A 5} + 2000 {S}_{A 6} + 2000 {S}_{A 7} + 2000 {S}_{A 8} + 2000 {S}_{D 1} + 2000 {S}_{D 2} + 2000 {S}_{D 3} + 2000 {S}_{D 4} + 2000 {S}_{D 5} & ( 36 ) \\ {y}_{10} = 3000 + 2000 {S}_{A 4} + 2000 {S}_{A 5} + 2000 {S}_{A 6} + 2000 {S}_{A 7} + 2000 {S}_{A 8} + 4000 {S}_{C 1} + 4000 {S}_{C 2} + 4000 {S}_{C 3} + 4000 {S}_{C 4} + 4000 {S}_{C 5} + 2000 {S}_{D 2} + 2000 {S}_{D 3} + 2000 {S}_{D 4} + 2000 {S}_{D 5} + 2000 {S}_{D 6} - 3000 {S}_{E 1} - 3000 {S}_{E 2} - 3000 {S}_{E 3} - 3000 {S}_{E 4} - 3000 {S}_{E 5} & ( 37 ) \\ {y}_{11} = 3000 + 2000 {S}_{A 5} + 2000 {S}_{A 6} + 2000 {S}_{A 7} + 2000 {S}_{A 8} + 4000 {S}_{C 2} + 4000 {S}_{C 3} + 4000 {S}_{C 4} + 4000 {S}_{C 5} + 2000 {S}_{D 3} + 2000 {S}_{D 4} + 2000 {S}_{D 5} + 2000 {S}_{D 6} - 2000 {S}_{D 7} - 3000 {S}_{E 2} - 3000 {S}_{E 3} - 3000 {S}_{E 4} - 3000 {S}_{E 5} & ( 38 ) \\ {y}_{12} = 2000 {S}_{A 6} + 2000 {S}_{A 7} + 2000 {S}_{A 8} + 4000 {S}_{C 3} + 4000 {S}_{C 4} + 4000 {S}_{C 5} + 2000 {S}_{D 4} + 2000 {S}_{D 5} + 2000 {S}_{D 6} + 2000 {S}_{D 7} + 2000 {S}_{D 8} + 3000 {S}_{E 1} + 3000 {S}_{E 2} & ( 39 ) \\ {y}_{13} = 2000 {S}_{A 7} + 2000 {S}_{A 8} + 4000 {S}_{C 4} + 4000 {S}_{C 5} + 2000 {S}_{D 5} + 2000 {S}_{D 6} + 2000 {S}_{D 7} + 2000 {S}_{D 8} + 3000 {S}_{E 2} + 3000 {S}_{E 3} & ( 40 ) \\ {y}_{14} = 2000 {S}_{A 8} + 4000 {S}_{C 5} + 2000 {S}_{D 6} + 2000 {S}_{D 7} + 2000 {S}_{D 8} + 3000 {S}_{E 3} + 3000 {S}_{E 4} & ( 41 ) \\ {y}_{15} = 2000 {S}_{D 7} + 2000 {S}_{D 8} + 3000 {S}_{E 4} + 3000 {S}_{E 5} & ( 42 ) \\ {y}_{16} = 2000 {S}_{D 8} + 3000 {S}_{E 5} & ( 43 )\end{matrix}$$

Then, equation (2) can be used to formulate Eₜ for the four periods of schedule as follows:

E₁=y₁+y₂+y₃+y₄+y₅ (44)

E₂=y₆+y₇+y₈+y₉+y₁₀ (45)

E₃=y₁₁+y₁₂+y₁₃+y₁₄+y₁₅ (46)

E₄=y₁₆ (47)

The four equations (44) through (47) are in terms of Sₖⱼ. Given the value of the multiplier K, the corresponding formulas of Pₜ can be performed using equation (3). Then, formulas for Uₜ, Vₜ, Iₜ, and Fₜ can be established in terms of Sₖⱼ using equations (4), (5), (8), and (7), respectively. Accordingly, five constraints can be established to express the conditions that F₁ through F₅ must be below specified cash constraints. Then, objective function in equation (17), activity sequence constraints in equations (18) through (22), activity shifting constraints in equations (23) through (27), and cash constraints represent an integer programming model that can be solved for Sₖⱼ values using available software.

It will be understood that the diagrams in the drawings depicting the CPM activity float extending method are exemplary only, and may be embodied in a dedicated electronic device having a microprocessor, microcontroller, digital signal processor, application specific integrated circuit, field programmable gate array, any combination of the aforementioned devices, or other device that combines the functionality of the CPM activity float extending method onto a single chip or multiple chips programmed to carry out the method steps described herein, or may be embodied in a general purpose computer having the appropriate peripherals attached thereto and software stored on a non-transitory computer readable media that can be loaded into main memory and executed by a processing unit to carry out the functionality of the apparatus and steps of the method described herein,

It is to be understood that the present invention is not limited to the embodiments described above, but encompasses any and all embodiments within the scope of the following claims.

I claim:

1. A computer-implemented method of extending Critical Path Method (CPM) activity floats, comprising the steps of:
acquiring CPM network and financial data, the CPM network data including activities and associated start and finish times for the activities, the financial data including disbursements and payments associated with the activities;
developing an extendable CPM network based on the acquired CPM network and financial data, the extendable CPM network having an initial float parameter of at least one definite additional float, the at least one definite additional float determining an extended duration of the CPM network when added to an initial terminal time;
formulating an integer programming model based on the extendable CPM network, the CPM network including cash constraints associated with the activities described in the CPM network;
using a computer to search for an optimized solution to the integer programming model, the optimized solution fulfilling the cash constraints and having extended floats within which the activities can be shifted while fulfilling an objective function of minimizing the duration of the extendable CPM network, including:
(a) adjusting an original schedule of the extendable CPM network by adding a user specified extension increment;
(b) supplementing a total float of a terminating activity of the extendable CPM network with the user specified extension increment, the terminating activity being a common activity in all paths traversing the extendable CPM network;
(e) delaying late start and late finish times within the extendable CPM network by the user specified extension increment;
(d) computing ranges from early start times in the network to the delayed late finish times in the network;
(e) generating new schedules based on the user specified extension increment by assigning random values to the start times of the activities within the ranges which are intercepted between the early start and delayed late start times of the activities, while maintaining dependencies among the activities;
returning the optimized solution if the optimized solution has been found;
increasing the initial float parameter; and
iteratively repeating the steps of developing the extendable CPM network, formulating the integer programming model, searching for an optimized solution, returning the optimized solution, and increasing the initial float parameter until the optimized solution has been found or a stopping criterion has been reached.

2. The computer-implemented method of extending CPM activity floats according to claim 1, further comprising the step of computing said objective function that minimizes total extension of a schedule via minimizing shifting in an activity in the schedule, said objective function computing step being characterized by a relation which minimizes z=xₙ where z is the objective function and xₙ are a plurality of activities at integer time period n in the schedule, where n=0, 1, 2, . . . n.

3. The computer-implemented method of extending CPM activity floats according to claim 1, further comprising the step of said computer computing activity shifting constraints
$${x}_{k} = {\sum }_{j = 1}^{{J}_{k}} {jS}_{kj} \qquad k = 1 , 2 , … , n$$
$${\sum }_{j = 1}^{{J}_{k}} {S}_{kj} \leq 1 \qquad k = 1 , 2 , … , n$$
on activities xₖ, said activity shifting constraints being characterized by the relations, where Jₖ=extended float of activity k and Sₖⱼ ∈ {0, 1} are binary variables.

4. The computer-implemented method of extending CPM activity floats according to claim 1, further comprising the step of said computer computing requisite activity sequence constraints between activity k and each of activities q ∈ Qₖ said activity sequence constraints being characterized by the relation:
EF_{q}≧(EFₖ+D_{q}) k=1, 2, . . . , n for all q ∈ Qₖ,
where EF_{q} is the early finish time of activity q, EFₖ is the early finish time of activity k, and D_{q} is a duration of activity q.

5. The computer-implemented method of extending CPM activity floats according to claim 1, further comprising the step of said computer computing a constraint on cumulative cash at any time period t with respect to specified constrained cash W, characterized by the relation Fₜ≦W where Fₜ is accumulated interest charge up to time t.

6. The computer-implemented method of extending CPM activity floats according to claim 5, further comprising the step of said computer computing a disbursement rate yₖᵢ based on disbursement rate Rₖ for activity k, in time unit i, the disbursement rate being characterized by the relations:
$$\begin{matrix}\begin{matrix}{y}_{ki} = ( 1 - {\sum }_{j = 1}^{{J}_{k}} {S}_{kj} ) {R}_{k} ; & {ES}_{k} \leq i \leq {EF}_{k}\end{matrix} & ( 16 a ) \\ \begin{matrix}{y}_{ki} = {S}_{kj} \cdot {R}_{k} ; & \begin{matrix}{ES}_{k} + j \leq i < {EF}_{k} + j & j = 1 , 2 , … , {J}_{k}\end{matrix}\end{matrix} & ( 16 b ) \\ \begin{matrix}{y}_{ki} = 0 ; & otherwise\end{matrix} & ( 16 c )\end{matrix}$$
where Jₖ=extended float of activity k and Sₖⱼ ∈ {0,1} are binary variables, ESₖ, is an early start time, and EFₖ is an early finish time.

7. The computer-implemented method of extending CPM activity floats according to claim 6, further comprising the step of said computer formulating said objective function and said constraints in terms of variables S associated with activity k having time shifting unit n where a value of “1” assigned to said variables Sₖₙ represents a value shift in activity k of n time units and a value of “0” assigned to said variables represents no time shift.

8. A computer software product, comprising a non-transitory medium readable by a processor, the medium having stored thereon a set of instructions for extending Critical Path Method (CPM) activity floats, the set of instructions including:
(a) a first sequence of instructions which, when executed by the processor, causes said processor to acquire CPM network and financial data, the CPM network data including activities and associated start and finish times for the activities, the financial data including disbursements and payments associated with the activities;
(b) a second sequence of instructions which, when executed by the processor, causes said processor to develop an extendable CPM network based on the acquired CPM network and financial data, the extendable CPM network having an initial float parameter of at least one definite additional float, the at least one definite additional float determining an extended duration of the CPM network when added to an initial terminal time;
(c) a third sequence of instructions which, when executed by the processor, causes said processor to formulating an integer programming model based on the extendable CPM is network, the CPM network including cash constraints associated with the activities described in the CPM network;
(d) a fourth sequence of instructions which, when executed by the processor, causes said processor to search for an optimized solution to the integer programming model, the optimized solution fulfilling the cash constraints and having extended floats within which the activities can be shifted while fulfilling an objective function of minimizing the duration of the extendable CPM network;
(e) a fifth sequence of instructions which, when executed by the processor, causes said processor to adjust an original schedule of said extendable CPM network by adding a user specified extension increment;
(f) a sixth sequence of instructions which, when executed by the processor, causes said processor to supplement a total float of a terminating activity of said extendable CPM network with said user specified extension increment, said terminating activity being a common activity in all paths traversing said extendable CPM network;
(g) a seventh sequence of instructions which, when executed by the processor, causes said processor to delay late start and late finish times within said extendable CPM network by said user specified extension increment;
(h) an eighth sequence of instructions which, when executed by the processor, causes said processor to calculate ranges from early start times in said network to said delayed late finish times in said network;
(i) a ninth sequence of instructions which, when executed by the processor, causes said processor to generate new schedules based on said user specified extension increment by assigning random values to said start times of said activities within said ranges which are intercepted between said early start and delayed late start times of said activities, while maintaining dependencies among said activities;
(j) a tenth sequence of instructions which, when executed by the processor, causes said processor to return the optimized solution if the optimized solution has been found;
(k) an eleventh sequence of instructions which, when executed by the processor, causes said processor to increase the initial float parameter; and
(l) a twelfth sequence of instructions which, when executed by the processor, causes said processor to iteratively repeat the steps of developing the extendable CPM network, formulating the integer programming model, searching for an optimized solution, returning a solution, and increasing the initial float parameter until the optimized solution has been found or a stopping criterion has been reached.

9. The computer software product according to claim 8, further comprising a thirteenth sequence of instructions which, when executed by the processor, causes said processor to calculate said objective function that minimizes total extension of a schedule via minimizing shifting in an activity in the schedule, said objective function calculation being characterized by a relation which minimizes z=xn where z is the objective function and xn are a plurality of activities at integer time period n in the schedule, where n=0, 1, 2, . . . n.

10. The computer software product according to claim 8, further comprising a fourteenth sequence of instructions which, when executed by the processor, causes said processor to calculate activity shifting constraints on activities xk, said activity shifting
$${x}_{k} = {\sum }_{j = 1}^{{J}_{k}} {jS}_{kj} \qquad k = 1 , 2 , … , n$$
$${\sum }_{j = 1}^{{J}_{k}} {S}_{kj} \leq 1 \qquad k = 1 , 2 , … , n$$
constraints being characterized by the relations,
where Jₖ=extended float of activity k and Sₖⱼ ∈ {0, 1} are binary variables.

11. The computer software product according to claim 8, further comprising a fifteenth sequence of instructions which, when executed by the processor, causes said processor to calculate requisite activity sequence constraints between activity k and each of activities q ∈ Qₖ said activity sequence constraints being characterized by the relation:
EF_{q}≧(EFₖ+D_{q}) k=1, 2, . . . , n for all q ∈ Qₖ,
where EF_{q} is the early finish time of activity q, EFₖ is the early finish time of activity k, and D_{q} is a duration of activity q.

12. The computer software product according to claim 8, further comprising a sixteenth sequence of instructions which, when executed by the processor, causes said processor to calculate a constraint on cumulative cash at any time period t with respect to specified constrained cash W, characterized by the relation Fₜ≦W where Fₜ is accumulated interest charge up to time t.

13. The computer software product according to claim 12, further comprising a seventeenth sequence of instructions which, when executed by the processor, causes said processor to calculate a disbursement rate yₖᵢ based on disbursement rate Rₖ for activity k, in time unit i, the disbursement rate being characterized by the relations:
$${y}_{ki} = ( 1 - {\sum }_{j = 1}^{{J}_{k}} {S}_{kj} ) {R}_{k} ; \qquad {ES}_{k} \leq i \leq {EF}_{k}$$
$${y}_{ki} = {S}_{kj} \cdot {R}_{k} ; \qquad \begin{matrix}{ES}_{k} + j \leq i < {EF}_{k} + j & j = 1 , 2 , … , {J}_{k}\end{matrix}$$
$${y}_{ki} = 0 ; \qquad otherwise$$
where Jₖ=extended float of activity if and Sₖⱼ ∈ {0,1} are binary variables, ESₖ, is an early start time, and EFₖ is an early finish time.

14. The computer software product according to claim 13, further comprising an eighteenth sequence of instructions which, when executed by the processor, causes said processor to formulate said objective function and said constraints in terms of variables S associated with activity k having time shifting unit n where a value of “1” assigned to said variables Sₖₙ represents a value shift in activity k of n time units and a value of “0” assigned to said variables represents no time shift.
